(19) United States
(12) Patent Application Publication
(10) Pub. No.: US 2008/0130088 A1
(43) Pub. Date: Jun. 5, 2008

(54) Display Device With Water-Based Electrolyte

(75) Inventors: Nicolaas P. Willard, Valkenswaard (NL); Henri Jagt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/815,566

(22) PCT Filed: Feb. 6, 2006
(86) PCT No.: PCT/IB06/50380

§ 371 Date: Aug. 6, 2007

(30) Foreign Application Priority Data
Feb. 9, 2005 (EP) 05100922.3

(51) Int. Cl. G02F 1/153; G02F 1/155

(52) U.S. Cl. 359/273; 359/265; 359/275

(57) ABSTRACT

A display device 1 comprises a base layer 2 and a top layer 4. A conduction layer 5 is applied to the base layer in a pattern, to form electrodes 6 and 8. These can be made of ITO coated with conductive PEDOT. An insulating isolation layer 14 is then applied in a pattern on top of the conduction layer 5 and fills in the spaces between the electrodes 6, 8 of the conduction layer 5. Gaps in the isolation layer 14 extend over a part of the electrodes. A conductive electrochromic material is deposited and fills in these gaps, to form redox centres 16 and 18 each in electrical contact with one of the electrodes 6 and 8. Sealing 20 defines a cavity, which is filled with a water-based electrolyte 22. The isolation layer 14 and the redox centres 16, 18 protect the electrodes 6,8 from the electrolyte. Providing a light source and using transparent materials for all of the base layer 2, the top layer 4, the electrodes 6 and 8, and the isolation layer 14 allows the device 1 to be used for the transmission of light. Alternatively, one of the top and base layers 2, 4 can be reflective and the other transparent, in which case the device 1 can be used for light reflection. By selecting suitable materials, a washable and flexible display device can be constructed.

The present invention relates to electrochromic display devices, and in particular, although not exclusively, to laminate, washable, flexible and wearable electrochromic display devices.

Electrochromic materials undergo a visible colour change or a change in optical density upon application of an electric field. Electrochromic materials are used in simple, mono-coloured signal devices. These devices can be used in large-scale applications, (e.g. windows, mirrors, sunglasses, sunroofs) or in small displays (e.g. mobile phone displays). These devices have the advantages of being bi-stable and having low energy consumption.

US 2003/0179432 describes an electrochromic display device with a combined electrochromic and electrolyte layer, arranged in an in-plane configuration. Two electrodes are placed on a base substrate, with a top transparent electrode attached over the entire surface of a top substrate. The current follows a path from one of the base electrodes through the electrolyte to the top electrode, along the top electrode, and then back down to the second bottom electrode through the electrolyte. In this way, a redox reaction takes place in the electrochromic electrolyte layer, and a change in colour is seen in the electrolyte in the layer just above the two bottom electrodes. The electrochromic device of U.S. Pat. No. 6,639,709 is similar, with the electrodes arranged into rows on a base layer and columns on a top layer, to form a sandwich configuration. Where the active row and active column voltages cross, a pixel becomes coloured.

U.S. Pat. No. 6,587,252 describes a supported electrochromic device wherein a solid electrolyte layer is in direct contact with the electrodes and with an electrochromic conducting material. The electrodes and the electrochromic material are not in direct contact with one another. The device is not washable, and the use of a solid electrolyte results in a slow switching speed of the device.

It is well known that the electrodes in existing devices are prone to degradation, resulting in increased switching times, and eventually to complete switching failure.

The inventors appreciate that it would be advantageous to use electrochromic display device technology on wearable items such as clothing. However, none of the prior art devices exhibit the desired characteristics of being at least partially flexible and washable.

According to the invention there is provided a display device comprising: non-conductive base and top layers mechanically separated to define a cavity, at least one of the base and top layers being water-permeable; water-based electrolyte contained in the cavity; at least two electrodes each formed on either of the base layer and the top layer; and hygroscopic electrochromic material electrically contactable with the electrodes.

This provides the possibility of a washable device, or at least a device which is able to regulate its water content. This can provide a device which is stable against water and switchable at low voltages, and which can be cheap and simple to manufacture. Electrochromic devices of this type may be useable on clothing, and provide a device which is more durable than the electrochromic devices currently being used on mobile devices and the like.

The electrochromic material may be in solution in the electrolyte. Preferably, however, the electrochromic material is in the form of at least two solid-phase redox centres each separating its electrode from the electrolyte. In this case, the device may comprise a non-conductive isolation layer arranged to separate parts at least one of the electrodes from the electrolyte. Providing separation of the electrodes from the electrolyte means that the device need not suffer problems of loss of conduction and degradation over time. This can also result in faster switching times than are found with devices in which the electrochromic material is dissolved in the electrolyte.

The electrodes may be comprised of a layer of a brittle conductive material with a flexible conductive material coating. Brittle substrate materials can thus be used in a flexible display, since the material of the coating can fill cracks that appear and thus allow the substrate to remain conducting. Preferably, ITO is coated with conductive PEDOT.

Preferably, a portion of each electrode extends outside the cavity to form a contact flap. This can allow for the simple connection of an electrical power source to the electrodes.

Advantageously, each of the components of the display device comprises a flexible material. This can make for a flexible display device, suitable for use on clothing and the like.

It is advantageous as well if each of the components of the display device comprises a polymer material.

Embodiments of the present invention will now be described, by way of example only, with reference to the accompanying drawings, in which:

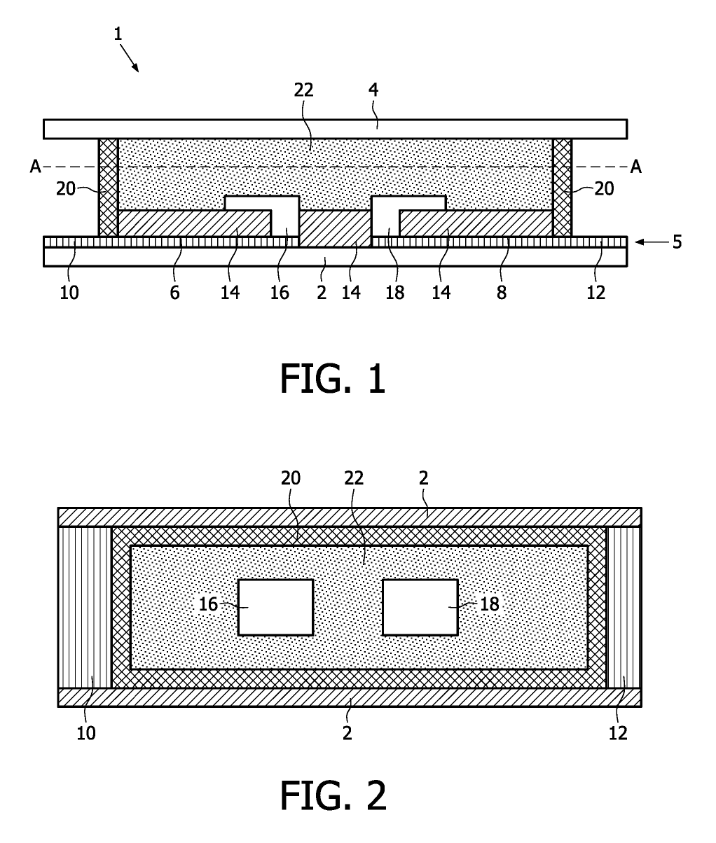

FIG. 1 is a cross-sectional side view of a first embodiment of a display device according to the invention;

FIG. 2 is a plan sectional view of the FIG. 1 display device, taken through the plane A-A in FIG. 1;

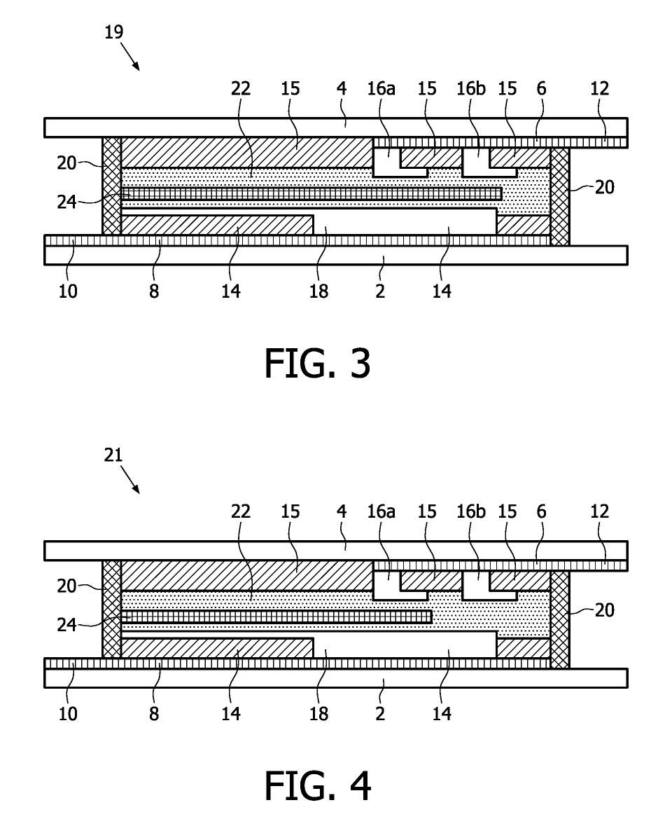

FIG. 3 is a cross-sectional side view of a second embodiment of a display device according to the invention;

FIG. 4 is a cross-sectional side view of a third embodiment of a display device according to the invention;

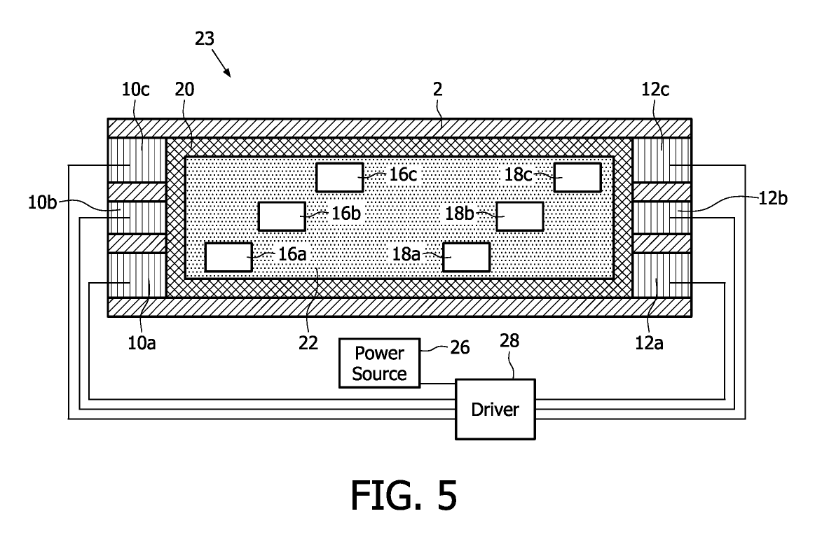

FIG. 5 is a plan sectional view of a fourth embodiment of a display device according to the invention; and

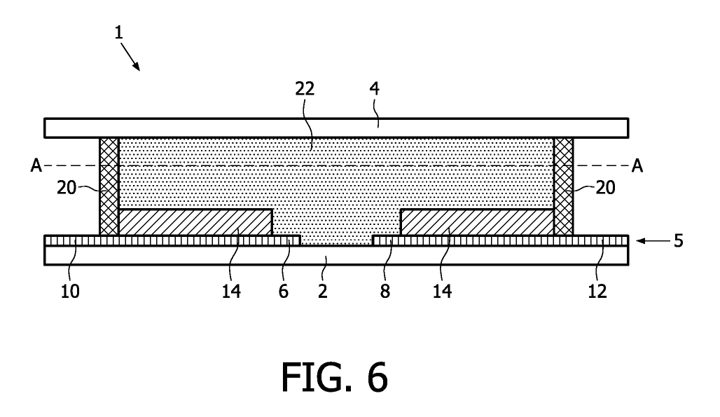

FIG. 6 is a cross-sectional side view of a fifth embodiment of a display device according to the invention.

In the Figures, reference numerals are re-used for like elements throughout.

Referring firstly to FIGS. 1 and 2, a display device 1 comprises a base layer 2 and a top layer 4 which provide mechanical and environmental protection. A conduction layer 5 is applied to the base layer in a pattern, to form electrodes 6 and 8. An insulating isolation layer 14 is then applied in a pattern on top of the conduction layer 5. The electrodes 6, 8 allow for a structured localised switching of electrochromic material. The isolation layer 14 fills in the spaces between the electrodes 6, 8 of the conduction layer 5 on the base layer 2. The isolation layer 14 does not extend to the edges of the conduction layer 5, so as to leave part of each electrode 6, 8 exposed. This provides a contact flap 10 and 12 for the electrodes 6, 8 respectively, to which voltage can be applied.

Gaps are left in the isolation layer 14. The gaps extend over a part of, and only over, the electrodes 6, 8. A conductive electrochromic material is deposited and fills in these gaps, to form redox centres 16 and 18. The redox centres 16,18 may occupy only the gaps. In this embodiment, however, the redox centres 16, 18 are proud of the upper surface of the isolation layer 14. They extend to a degree over the top surface of the isolation layer 14. Each redox centre 16 and 18 is in electrical contact with one of the electrodes 6 and 8. Sealing 20 is applied around the edges of the device 1. The sealing 20 keeps the base layer 2 and top layer 4 mechanically separated to define a cavity. The cavity is filled with electrolyte 22. The isolation layer 14 and the redox centres 16, 18 protect the electrodes 6, 8 by separating them from the electrolyte 22. The sealing 20 encloses the device and prevents any leakage of the electrolyte 22. The sealing 20 is applied in such that no part of the electrodes 6 and 8 not covered by the isolation layer 14 or the redox centres 16 and 18 is within the area defined by the sealing. The electrolyte 22 fills the cavity formed by the top layer 4, the isolation layer 14, the redox centres 16, 18 and the sealing 20. The electrolyte comprises a suitable salt dissolved in water.

Providing all of the base layer 2, the top layer 4, the electrodes 6 and 8, and the isolation layer 14 with transparent materials allows the device 1 to be used for the transmission of light. A light source (not shown) may be required in this case. Alternatively, one of the top and base layers 2, 4 can be reflective and the other transparent, in which case the device 1 can be used for light reflection. Any of the transparent base and top layers 2, 4 may have colour.

In use, a voltage is applied to the electrodes 6 and 8 via the contact flaps 10 and 12, providing a current flow and therefore a net flow of electrons through a circuit comprising, in sequence the first electrode 6 (which becomes the working electrode), the first redox centre 16, the electrolyte 22, the second redox centre 18 and the second electrode 8 (which becomes the counter electrode). A reduction reaction (gain of electrons) occurs at the surface of the redox centre 16 above the working electrode 6 where it contacts the electrolyte 22, since electrons are consumed to enable the current to flow. An oxidation reaction (loss of electrons) occurs at the surface of the second redox centre 18 above the counter electrode 8 where it contacts the electrolyte 22, since electrons are freed to enable the current to flow. Ions in the electrolyte 22 are shifted towards and away from the first and second redox centres 16 and 18 to compensate the charge changes induced there, thereby completing the electrical circuit. The process of complementary reactions at two electrodes connected in some way through an electrolyte layer is known as a redox couple. The charge change that occurs at the first and second redox centres 16, 18 causes a colour change there, provided that a sufficient potential difference is set up between the working electrode 6 and the counter electrode 8.

When the electrochromic material has two stable states, A and B, applying a voltage causes the first redox centre 16 to be in state A, and the second redox centre 18 to be in state B. These states are bi-stable—when the voltage is removed, the redox centres remain in those states. When the voltage is reversed, the first redox centre 16 changes to state B, and the second redox centre 18 changes to state A. State A possesses colour, and state B may also possess colour.

The magnitude of the optical change in the first and second redox centres 16 and 18 is dependent on the capacity of the redox centres 16 and 18. The smaller the surface area of the redox centre which is exposed to electrolyte, the larger is the current density change per unit area, and therefore the larger the optical change. Thus, by providing suitably sized redox centres 16, 18, the device 1 can be arranged to ensure that the first redox centre 16 on the working electrode 6 has a sufficiently brighter signal than the second redox centre 18 on the counter electrode 8.

The first and second redox centres 16 and 18 are preferably placed near to each other, resulting in a faster switching speed of the device 1 than when the redox centres 16, 18 are remote from each other.

If it is required to hide of one of the first and second redox centres 16, 18, that redox centre 16, 18 can be masked by one of two methods. Firstly, an opaque pattern (not shown) can be printed onto either the top layer or the bottom layer 7 to mask one of the redox centres 16, 18. Alternatively, a scattering electrolyte layer can be applied in front of one of the redox centre 16, 18. The latter is preferable when the device is used for the reflection of light. The isolation layer 14 separates the parts of the electrodes 6 and 8 that are not contacting the first and second redox centres 16 and 18 from the electrolyte 22. If the electrodes 6 and 8 were in contact with the electrolyte 22, a redox reaction would occur on the electrodes 6, 8 as well as on the redox centres 16, 18. The isolation layer 14 thus prevents ions from the electrolyte 22 migrating to the electrodes 6, 8. This has two advantages. Firstly, it ensures that an electrochemical reaction at the first and second redox centres 16, 18 is efficient, as this is where all the charge changes are induced. Secondly, it protects the electrodes 6, 8 from electrochemical degradation, which would eventually cause a loss of conduction in the device 1. Loss of conduction typically results in longer switching times, more power losses and, ultimately, complete switching failure. If the material for the electrodes 6, 8 is slightly electrochromic, as many suitable materials are, the electrodes would be visible where they contact with the electrolyte 22, which is undesirable, and there would also be a loss of conduction through the first and second redox centre centres 16, 18. In some materials, the electrochromic effect is poorly reversible, leading to device degradation over time. The isolation layer 14 also can be applied in a pattern, resulting in a corresponding pattern when the device 1 is used since there is no switching of the electro-chromic material where it is covered with the isolation layer.

In some devices 1, the presence of an isolation layer 14 may not be necessary. If the first and second redox centres 16, 18 cover the entire surface and edges of the electrodes 6,8 that are inside the cavity, and thus no part of any electrode 6, 8 is in contact with the electrolyte 22, then there is no added benefit to the addition of an isolation layer 14. Even if this is not the case, the isolation layer 14 may not be an essential part of the device, although its presence is preferred at least since it can extend the useful lifetime of the device by protecting the electrodes 6 and 8, from the electrolyte 22.

FIG. 3 shows a second embodied display device 19. In this embodiment, the working electrode 6 is applied to the lowermost surface of the top layer 4 of the device 19. A second isolation layer 15 is applied to the electrode 6, to protect it from degradation through contact with the electrolyte 22. First and third redox centres 16a, 16b are present in the gaps left by the second isolation layer 15, and provide electrical contact between the counter electrode 6 and the electrolyte 22. The Figure also shows a scattering electrolyte layer 24. The scattering electrolyte layer 24 wholly overlaps the second redox centre 18. The scattering electrolyte layer 24 masks the second redox centre 18 and prevents it being visible.

FIG. 3 shows the contact flap 12 (not shown) present on the lower most surface of the top layer 4. Alternatively, the contact flap 12 may be present on the base layer 2, and be connected to the counter electrode 8 through a conductive connection (not shown) on the sealing 20.

To optimise the second embodied display device 19 for reflection of light, the base layer 2 is reflective and the top layer 4 is transparent. Here, ambient light is incident through the top layer 2, the working electrode 6, the first and third redox centres 16a, 16b and the electrolyte 22. Light is scattered from the scattering layer 24 back to the eye of the user so that the counter electrode 8 and the second redox centre 18 are not visible. Light is also scattered back to the eye of the user from the base layer 2.

The arrangement of electrodes 6, 8 in the second embodied display device 19 has an advantage of providing a higher information density at the working electrode 6, since there is more space available on the top layer 4 to form the first and third redox centres 16a, 16b. The redox centre 18 on the counter electrode 8 has a large surface area so that the electrochromic colouration is minimised.

FIG. 4 shows a third embodied display device 21. The display device 21 is similar to the display device 19. However, in this case, the scattering electrolyte layer 24 does not wholly overlap the second redox centre 18. The section of the second redox centre 18 beneath the first redox centre 16a is masked, and the section of the second redox centre 18 beneath the third redox centre 16b is not masked.

Thus there is more versatility in the pattern that can be produced.

The observable optical effect can be controlled by the overlap between the third redox centre 16b and the second redox centre 18: A third colour, which is a combination of the colour on the third redox centre 16b and the colour on the second redox centre 18, is produced where the second and third redox centres 16b and 18 overlap, and where no masking is present.

FIG. 5 is a plan view of a third embodied display device 23. Six electrodes (not shown) and first to sixth redox centres 16a, 16b, 16c, 18a, 18b, 18c are provided. Each electrode has a respective contact flap 10a, 10b, 10c, 12a, 12b and 12c which extends outside the area defined by the sealing 20. In the Figure, each electrode has a respective redox centre 16a, 16b, 16c, 18a, 18b and 18c. However, the device 23 is not limited to one redox centre per electrode. Any pattern of redox centre may be present on each electrode. There can be more than one redox centre on each electrode. An isolation layer (not visible in the Figure) provides insulation between the electrodes.

A power source 26 is connected to each of the contact flaps 10a, 10b, 10c, 12a, 12b, 12c via a driver 28. The power source 26 provides the potential difference required for redox reactions to occur. The driver 28 determines what voltages are applied to which contact flaps. The driver 28 also determines the magnitude of the voltage applied to each contact flap (10a, 10b, 10c, 12a, 12b, 12c), and therefore determines the magnitude of the optical change at the redox centre corresponding to that contact flap. In addition, the driver 28 determines the length of time that each contact flap 10a, 10b, 10c, 12a, 12b, 12c has a voltage applied to it. This allows the provision of versatile, animated displays.

A discussion of materials suitable for the various components of the devices now follows.

In all of the devices 1, 19, 21, 23 the base layer 2 and the top layer 4 are preferably constructed from a flexible material. Preferably, at least one of the base layer 2 and the top layer 4 is constructed from a transparent material. Suitable materials are PET (polyethylene terephthalate) and PEN (polyethylene naphthalate), although any mechanically stable material can be used including, but not limited to, glass, paper, or coated paper. The use of glass is not preferred when using the display device as a wearable device, as glass is fragile. Preferably at least one of the base layer 2 and the top layer 4 is water permeable. This allows water to pass between the electrolyte 22 and atmosphere, contributing to the washability of the device.

In the preferred embodiments, both the base layer 2 and the top layer 4 are transparent so to allow for transmission of light. Either or both of the base layer 2 and the top layer 4 may have colour.

PET is a preferred material for either or both of the base layer 2 and top layer 4, as it is a relatively good water barrier (although the permeability depends on its thickness), and is resistant to washing. PET does not degrade upon contact with water. Additionally, PET is transparent and flexible, and is readily and cheaply available. The above mentioned qualities of PET make it suitable for use in wearable display devices. PEN also shares these qualities. Although PEN is more thermally and water vapour resistant then PET, it is not currently so readily and cheaply available as PET.

Other materials are suitable for use as the top and base layers 2, 4.

If the electrochromic display device is used for the transmission of light, both the base layer 2 and the top layer 4 should be transparent. A light source may be required. The exact type of light source used is dependent on the availability of power and the thickness of the device.

Electro-luminescent (EL) light sources in thin film form are suitable for use in electrochromic display devices, and are commercially available. They can be as thin as 0.3 mm and are available to provide coloured or white light. They are available in high voltage and low voltage versions. The electroluminescent materials can be inorganic or organic. EL light sources can be sandwiched between two transparent layers to form the base layer 2.

Side emitting backlight systems can also be used. Here, a light guide covers the back of the electrochromic display device, and at least one light source is situated on at least one of the edges of the light guide. The light source can take the form of a light emitting diode (LED) or a cold cathode fluorescent lamp (CCFL). Light guides usually are 1-2 mm thick. The light from each light source travels through the light guide. Structures, such as microgrooves or surface gratings, are present on one of the surfaces of the light guide to enable the light to escape and therefore illuminate the device.

Alternatively, an array of LEDs or thin fluorescent lamps can be provided behind the electrochromic display device. In this case, it is preferable that an additional scattering layer is present, so as to prevent the shape of the light source being visible. This can alter the display to be homogenously illuminated.

If the electrochromic display device is used in reflective operation, either one of the base layer 2 or top layer 4 is formed from a reflecting substrate, while the other is transparent. The reflecting substrate can be an insulating material with a layer of reflective material located such that it is on the outside of the device. The layer of reflective material can be placed within either one of the base layer 2 or top layer 4 to form the reflecting substrate. Alternatively, a scattering material or metal is associated with the base layer 2 or the top layer 4. Another alternative is to provide a non-reflective base layer 2 and top layer 4, and to use reflective metallic electrodes on either one of the base layer 2 and top layer 4. Yet another alternative is to provide a metallic base layer 2 forming one large counter electrode, where the working electrode is present on the transparent top layer 4. Alternatively, the metallic base layer 2 can be covered with a thin insulating layer across its entire surface, with electrodes 6 and 8 provided on top.

The electrodes 6 and 8 may be formed of any suitably conductive material. Preferably, the electrodes 6, 8 are transparent. Currently available transparent conducting materials include, but are not limited to, metal oxides, such as ITO (Indium Tin oxide, also electrochromically active), ATO (Antimony Tin oxide) or IZO (Indium Zinc oxide), and conductive polymers such as PEDOT (poly(3,4-ethylene-dioxythiophene)). Metal oxides have the advantage that they are highly conductive, and are therefore suitable for coating large areas. However, metal oxides have the disadvantage that they are brittle, and can crack upon bending, leading to a loss in conduction. Conductive polymers such as PEDOT are highly flexible, however they may not be as conductive as metal oxides.

The inventors have realised that a layer of brittle metal oxide (e.g. ITO) covered with a layer of flexible, conductive polymer (e.g. PEDOT) can provide durable large displays. Any cracks that appear in the layer of metal oxide upon bending, potentially leading to local conduction losses, are filled by the conductive polymer, and the electrodes then continue to be conductive. In this way, large displays (which typically require highly conductive electrodes) can be made flexible. The same applies to many other brittle conductive materials and many other flexible conductive materials. Usually, the brittle material has a higher conductivity than the flexible material.

Alternatively, the electrodes 6 and 8 may be formed of a metal. In this case, it is preferable to mask the visible sections of the electrode 6, 8 with an opaque pattern on either the base layer 2 or the top layer 4, or with a scattering electrolyte layer 24 in front of the visible portion of the electrodes.

Any other suitable material may be used instead for the electrodes 6, 8.

Providing all the electrodes 6, 8 on the same layer, as shown in FIG. 1, reduces the cost of the device as a complex manufacturing process is only required for only one of the layers.

Metal and metal oxide electrodes 6, 8 can be applied to the base layer 2 and/or the top layer 4 using lithographic wet chemical processing. Conductive polymer electrodes can be applied by screen printing, flexographic printing or inkjet printing. Alternatively, any other suitable method can be used to apply the electrodes 6, 8.

The isolation layer 14 preferably is transparent. It preferably is water resistant. Preferably it is flexible. Many readily available materials can be used for the isolation layer 14. Examples are waxes and non-conductive polymers. The isolation layer 14 can be applied by lithographic photo-resist technology, screen printing, flexographic printing, inkjet printing or any other method, with the method chosen being used dependent on the material used.

The redox centres 16 and 18 in the FIGS. 1 to 5 embodiments are formed from a solid-phase electrochromic material. They are solid phase in part since the material has a low solubility in the electrolyte 22, so does not become dissolved therein. The redox centres 16 and 18 are conducting, though they might not have a high conductivity. It is preferable but not necessary that the redox centres 16, 18 are made from a flexible material. The material used for the redox centres 16, 18 may be the same chemical type as that used for the electrodes 6, 8, but differently doped so that it has different properties. For example, PEDOT exists in different grades of conductivity. Highly conductive PEDOT can be used for the electrodes 6 and 8. Lower conductivity, but highly electrochromic, PEDOT may be used for the redox centres 16 and 18. Highly conductive PEDOT is usually more expensive than PEDOT with a low conductivity. PEDOT, as previously mentioned, is flexible. It switches between a transparent state and a blue state on application of a voltage difference (approximately 1.5V).

PEDOT is commercially available as a water-based latex. PEDOT layers can be natively applied from a water-based dispersion, which causes the PEDOT layers to be quite hygroscopic after drying, but still enables good electrochromic switchability. Therefore, the display 1, 19, 21, 23 can tend to regulate its own water content if the electrolyte 22 is water-based.

The redox centres 16, 18 may instead be made of an organic electro-chrome adsorbed on nano sized particles.

If no colouration is wanted at the counter electrode 8, the material of the redox centre 18 is chosen so as not to be electrochromic. Preferably, the redox centre 18 is formed of a transparent material if the device is used for the transmission of light. Preferably, the redox centre 18 is formed of a reflective material if the device is used for the reflection of light. The redox centres 16 and 18 are applied by screen printing, flexographic printing, inkjet printing or any other method known in the art.

The electrolyte 22 is water-based. Switching can occur at low voltages (0.8V-1.5V) in water-based systems. Using a plastic such as PET for the base layer 2 and top layer 4 is preferable for wearable devices as it is flexible. However, PET is slightly water-permeable.

In non-water based systems, even a slight amount of water entering the device can destroy the operation of the device. Therefore PET cannot be used for the base layer 2 and top layer 4 in non-water based systems. Instead, the base layer 2 and the top layer 4 are usually made from a plastic film with an inorganic coating to ensure it is completely water-impermeable. However, this can be expensive.

With a water-based electrolyte 22, the device remains operational even if a small amount of water enters of leaves the device (i.e. there is no critical moisture sensitivity), so a PET film can be used for the base layer 2 and top layer 4. The preferred thickness of the PET film is around 100 μm, as at this thickness it is sufficiently flexible. Depending on the requirements of it, the PET film may be any thickness between 10 μm and 2 mm. In this way, the device can be made flexible, and yet still operable if exposed to wet or humid conditions.

Therefore, the device can be made washable by using a water-permeable material for one or more of the base layer 2, the top layer 4 and the sealing 20 and using a water-based electrolyte 22. Water-based electrolytes 22 have the additional advantages of being cheap, environmentally friendly, less toxic and non-corrosive.

Whereas in current electrochromic applications, salts are dissolved in solvents such as acetonitrile or propylene carbonate and water is excluded from the system, this is not the case with some embodiments of the invention. With non-aqueous devices, the voltages that can be applied are higher. These higher voltages would induce a reaction with water, forming oxygen and hydrogen gas, which is highly unwanted. However, this is avoided in the invention by using a hygroscopic electrochromic material, such as PEDOT/PSS, deposited from a watery solution. In this way, it is difficult to remove water from the system. Also, PEDOT gives a significant colour change already at low voltages at which water is not reacting. This also allows the use of plastic substrates, instead of the conventional glass. Glass is hermetic to moisture and oxygen, but plastic is not. Therefore water will penetrate the system anyway unless expensive moisture and gas barrier layers are applied to the plastic, but this is not a problem if water-based electrolyte and a hygroscopic electrochromic material is used. This can be said to provide a water-based system.

In a water-based system, if more water is added (from a wet environment), there is no significant change is device operation. If water is extracted (by a dryer environment) also no significant change is made. Only when the water is removed totally, for example through high temperatures and/or drought, will the mobility of the electrolyte be reduced. Even then, the hygroscopic nature of the system attracts water back when put in a wet environment. The extent to which the system is hygroscopic can be maximized: the PEDOT/PSS is hygroscopic, the salt included in the electrolyte 22 is hygroscopic and further water dissolvable molecules such as polyvinylalcohols or polyethyleneglycols that are also highly hygroscopic by their favourable molecular interaction with water can be added. It can be said therefore that the device can be washable, for applications such as signage, displays in clothes, etc.

The water-based electrolyte 22 is preferably a polymer. The electrolyte 22 can be a liquid, a gel or a solid. A solid electrolyte 22 provides mechanical robustness. It can provide mechanical separation of the base layer 2 and the top layer 4, to keep them at a fixed distance from one another. In a solid electrolyte 22, switching times can be as long as one second or more due to low carrier mobility. A liquid electrolyte 22 benefits from fast switching times due to increased carrier mobility. A device with a liquid electrolyte 22 preferably has supporting structures such as spacers 20, to provide mechanical robustness of the device. A gelled electrolyte 22 has the benefit of mechanical support combined with high carrier mobility. Sealing 20 might not be necessary when a solid electrolyte 22 is used.

A discussion of techniques used in the production of the devices now follows.

When the electrolyte 22 is liquid, it is applied after the sealing 30, through filling ports by capillary or vacuum filling. If the liquid electrolyte 22 has reactive molecules, it can be illuminated with UV light (photopolymerisation) or thermally cured to form a polymer, resulting in a gelled or solid electrolyte 22. A solid or gelled electrolyte 22 can be printed from a solution or while in a liquid phase. The viscosity of the liquid is tuned to the printing method. Screen printing, flexographic printing and inkjet printing are potentially suitable printing techniques. The liquid electrolyte 22 is then dried or cured using the methods described above to provide a mechanically stable, tacky layer onto which the top layer 4 is laminated or coupled. The coupling can be room temperature lamination, or lamination at higher temperatures, optionally in combination with pressure (e.g. vacuum pressure).

The scattering electrolyte layer 24 can be printed onto the electrolyte 22. Optionally a layer of electrolyte 22 is printed on top of the scattering electrolyte layer 24. The scattering electrolyte layer 24 is formed of the same material as the electrolyte 22, and also contains scattering particles. It is applied using the same methods as those used to apply the electrolyte 22.

The scattering particles are small particles such as titanium dioxide nanoparticles, which are 200 nm in diameter. Alternatively, a phase-separated electrolyte is formed from small liquid droplets in a solid polymer matrix.

The scattering electrolyte layer 24 is preferably used to mask the counter electrode 8 when the electrochromic display device is used in reflective operation. If the scattering electrolyte layer 24 is used to mask the counter electrode 8 when the device is being used for transmission of light, any unwanted colouring at the counter electrode 8 still is visible. However, the scattering electrolyte layer 24 can be used to mask inhomogeneities in the light source or to mask structures in the counter electrode 8.

It may also be required to maintain the base and top layers 2, 4 in generally parallel planes by the provision of spacers (not shown). The presence of spacers is most useful when the electrolyte 22 is a liquid electrolyte. Preferably the spacers are placed at regular intervals.

For rigid components, glass spheres form suitable spacers, where the diameter of the spheres defines the height of the cavity. The glass spheres are spin-coated onto the base layer 2 or top layer 4, or alternatively electrostatically deposited onto the base layer 2 or top layer 4. Alternatively, the glass spheres are printed when the glass is in solution, and the solvent is later removed by evaporation.

For flexible devices, the use of spacers is preferable as they prevent excessive bending of the base layer 2 and top layer 4. Preferably the spacers are polymeric in this case. The spacers are applied using a lithographic process in which a photoresist material dissolved in a liquid is applied by spin coating to form a uniform layer. The liquid is removed by evaporation after deposition. The layer is illuminated using UV radiation through a mask to react some parts of the material, forming a non-soluble layer in these parts. The layer is developed using a developer liquid that dissolves all the remaining non-soluble parts to form spacers. Alternatively, the spacers can be formed by embossing either one of the base layer 2 or top layer 4. Either one of the base layer 2 or the top layer 4 can be injection moulded into a mould containing an inverse spacer pattern to form spacers. The spacers might also be formed by UV-replication of spacer structures from a mould with inverse spacer patterns.

The sealing 20 can be made of any conventional sealing material, or can be made of the same material as the isolation layer 14. If the electrolyte 22 is liquid, the sealing is applied before the electrolyte 22 by dispensing or printing a seal line (not shown), coupling the base layer 2 with the top layer 4 via the seal line, curing the seal line and then filling the cavity with the electrolyte 22 through filling ports. If the electrolyte 22 is printed, the sealing 20 might be applied in advance, or after the electrolyte processing.

Although the above embodiments have been described using a solid-phase redox centre, in some embodiments of a water-based device the electrochromic material is dissolved in the electrolyte 22. One such embodiment will now be described with reference to FIG. 6. Here, in a device 30, when a voltage is applied to the contact flaps 10, 12 the electrochromic material migrates to the electrodes 6,8 to pick up or release electrons. The redox reaction that occurs between the electrochromic material and the electrodes 6, 8 can form a soluble material or a solid deposit on the electrodes 6, 8. Reversing the voltage re-dissolves any deposit that has formed on the electrodes 6 and 8. The migration process of the electrochromic material to the electrodes 6 and 8 is rate limiting and results in a slow switching speed (typically 10 seconds to one minute). An isolation layer 14 can be provided to mask parts of the electrodes 6, 8 from the electrolyte. Redox reactions only occur at the parts of the electrode 6, 8 in contact with the electrochromic electrolyte 22, therefore there is a colour change only at the exposed parts of the electrodes.

Although the present invention has been described with respect to the above embodiments, it should be apparent to those skilled in the art that modifications can be made without departing from the scope of the invention.

1. A display device comprising:
non-conductive base and top layers (2, 4) mechanically separated to define a cavity, at least one of the base and top layers (2, 4) being water-permeable;
water-based electrolyte (22) contained in the cavity;
at least two electrodes (6,8) each formed on either of the base layer (2) and the top layer (4); and
hygroscopic electrochromic material electrically contactable with the electrodes (6, 8).

2. A display device as claimed in claim 1, wherein the electrochromic material is in solution in the electrolyte (22).

3. A display device as claimed in claim 1, wherein the electrochromic material is in the form of at least two solid-phase redox centres (16, 18) each separating its electrode (6, 8) from the electrolyte (22).

4. A display device as claimed in claim 3, comprising a non-conductive isolation layer (14) arranged to separate parts at least one of the electrodes (6, 8) from the electrolyte (22).

5. A display device as claimed in claim 3, comprising a scattering electrolyte layer (24) aligned with at least one of the electrodes (6,8).

6. A display device as claimed in claim 5, in which:
a first one of the redox centres (16) contacts an electrode (6) on the base layer (2) or the top layer (4);
a second one of the redox centres (18) contacts an electrode (8) on the other of the base layer (2) or top layer (4);
wherein the first redox centre (16) and the second redox centre (18) overlap and wherein the scattering electrolyte layer (24) exposes at least a portion of the overlapping electrodes.

7. A display device as claimed in claim 1, wherein the electrodes (6, 8) are comprised of a layer of a brittle conductive material with a flexible conductive material coating.

8. A display device as claimed in claim 1, wherein a portion of each electrode (6, 8) extends outside the cavity to form a respective contact flap (10, 12).

9. A display device as claimed in claim 8, wherein the contact flaps (10, 12) are connected to a power source (26) via a driver (28).

10. A display device as claimed in claim 1, wherein each of the components of the display device comprises a flexible material.

11. A display device as claimed in claim 1, wherein each of the components of the display device comprises a polymer material.

12. A display device as claimed in claim 1, wherein the base and top layers (2, 4) are maintained in generally parallel planes by spacers.

13. A display device as claimed in claim 1, wherein either or both of the base and top layers (2, 4) comprises transparent material.

14. A display device as claimed in claim 1, wherein one of the base and top layers (2, 4) is reflective and the other of the base and top layers is transparent.
